(19) United States
(12) Patent Application Publication
(10) Pub. No.: US 2009/0113448 A1
(43) Pub. Date: Apr. 30, 2009

(54) SATISFYING A REQUEST FOR AN ACTION IN A VIRTUAL WORLD

(76) Inventors: Andrew Bryan Smith, Morrisville, NC (US); Brian Ronald Bokor, Raleigh, NC (US)

Correspondence Address: MOORE & VAN ALLEN, PLLC For IBM, P.O. Box 13706, Research Triangle Park, NC, 27709, US

(21) Appl. No.: 11/926,350

(22) Filed: Oct. 29, 2007

(51) Int. Cl. G06F 9/44

(52) U.S. Cl. 719/314

(57) ABSTRACT

A method for satisfying a request for an action in a virtual world includes permitting a user to request a first action for an avatar in the virtual world, wherein the avatar corresponds to the user. The method may also include determining if the first action is unavailable for the user's avatar at the time of the request. The method may additionally include permitting a user's avatar to perform another action while the first action is unavailable for the user's avatar. The method may yet additionally include determining if the first action becomes available for the user's avatar. The method may further include notifying the user that the first action is available for the user's avatar in response to the first action being determined to be available. The method may yet further include allowing the user to accept the first action. And the method may include allowing the user's avatar to perform the first action in response to the user accepting the first action.

### BACKGROUND OF THE INVENTION

The present invention relates to simulations, virtual world simulations of the real-world or real-life or a virtual world and the like, and more particularly to a system and method for satisfying a request for an action in a virtual world.

Computer based simulations are becoming more ubiquitous. Simulations may be used for training purposes, for entertainment or for other purposes. Computer simulations such as Second Life™ or similar simulations present a virtual world which allows users or players to be represented by characters known as avatars. Second Life is a trademark of Linden Research, Inc. in the United States, other countries or both. Second Life is an Internet-based virtual world launched in 2003 by Linden Research, Inc. A downloadable client program called the Second Life Viewer enables users, called “Residents”, to interact with others in the virtual world through motional avatars. The virtual world basically simulates the real world or environment. The users or residents via their avatar can explore the virtual world, meet other users or residents, socialize, participate in individual and group activities, create and trade items (virtual property) and services from one another.

Occasionally, services and locations in the virtual world can become overloaded. An avatar requesting an overloaded service or location may have to wait for that service or location to become available. In the meantime, if avatars choose to navigate to other locations, they currently have to withdraw their request for their requested services or access to locations to do this. Accordingly, the avatars window of opportunity for their requested service or access to a location can close.

### BRIEF SUMMARY OF THE INVENTION

In accordance with an aspect of the present invention, a method for satisfying a request for an action in a virtual world may include permitting a user to request a first action for an avatar in the virtual world, wherein the avatar corresponds to the user. The method may also include receiving the request and storing the request in a queue in response to the first action being unavailable to the user's avatar. The method may additionally include permitting the user's avatar to perform another action while the request for the first action is still in the queue. The method may further include determining if the first action becomes available for the user's avatar and providing a graphical user interface to the user in response to the first action being determined to be available for the user's avatar. The method may yet further include allowing the user to accept the first action and allowing the user's avatar to perform the first action in response to the user accepting the first action.

In accordance with another aspect of the present invention, a method for satisfying a request for an action in a virtual world may include permitting a user to request a first action for an avatar in the virtual world, wherein the avatar corresponds to the user. The method may also include determining if the first action is unavailable for the user's avatar at the time of the request and permitting a user's avatar to perform another action while the first action is unavailable for the user's avatar. The method may yet additionally include determining if the first action becomes available for the user's avatar and notifying the user that the first action is available for the user's avatar in response to the first action being determined to be available. The method may yet further include allowing the user to accept the first action and allowing the user's avatar to perform the first action in response to the user accepting the first action.

In accordance with another aspect of the present invention, a method for satisfying a request for an action in a virtual world may include presenting a graphical user interface to permit a user to request a first action for an avatar in the virtual world, wherein the avatar corresponds to the user. The method may also include receiving a request for the first action and performing the first action in response to the first action being available for the user's avatar. The method may additionally include providing a notification that the first action is unavailable in response to the first action being unavailable for the user's avatar at the time that the user requests the first action. The method may further include storing the request for the first action in a queue in response to the first action being unavailable for the user's avatar at the time that the user requests the first action. The method may yet further include permitting the user's avatar to perform another action while the request for the first action is still in the queue. The method may yet further include determining if the first action becomes available for the user's avatar and sending a notification of availability of the first action in response to the first action being determined to be available for the user's avatar. The method may additionally include providing a graphical user interface to the user in response to the first action being determined to be available for the user's avatar and providing a predetermined time period for allowing the user to accept the first action. The method may further include performing the first action in response to the user accepting the first action within a predetermined time. The method may yet further include allowing the user's avatar to continue to perform the other action in response to the user not accepting the first action within the predetermined time period and dropping the user's request for the first action from the queue in response to the user not accepting the first action within the predetermined time period.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIGS. 1A and 1B (collectively FIG. 1) are a flow chart of an example of a method for satisfying a request for an action in a virtual world in accordance with an embodiment of the present invention.

FIG. 2 is a block schematic diagram of an example of a system for satisfying a request for an action in a virtual world in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages, or in functional programming languages, such as Haskell, Standard Meta Language (SML) or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

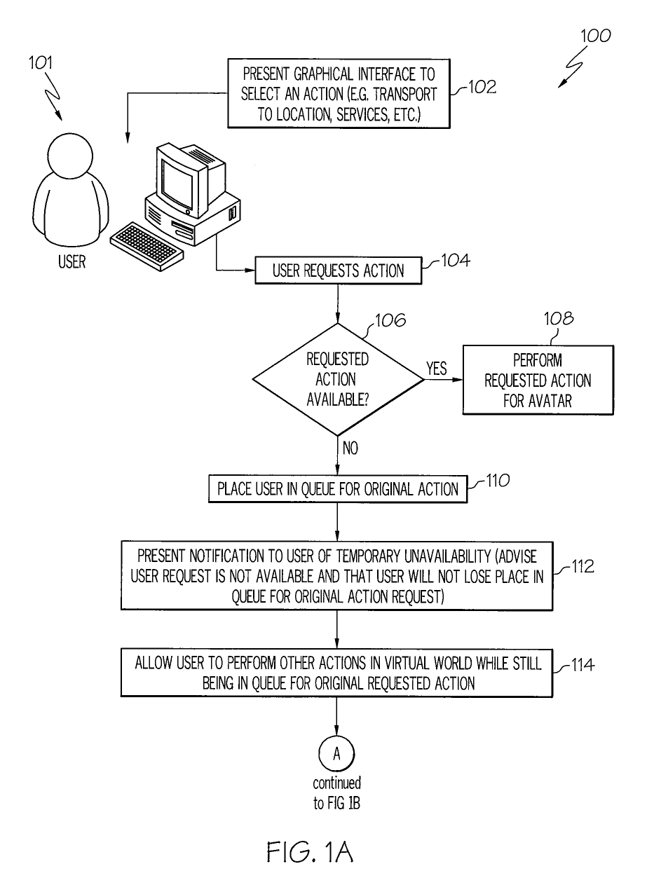

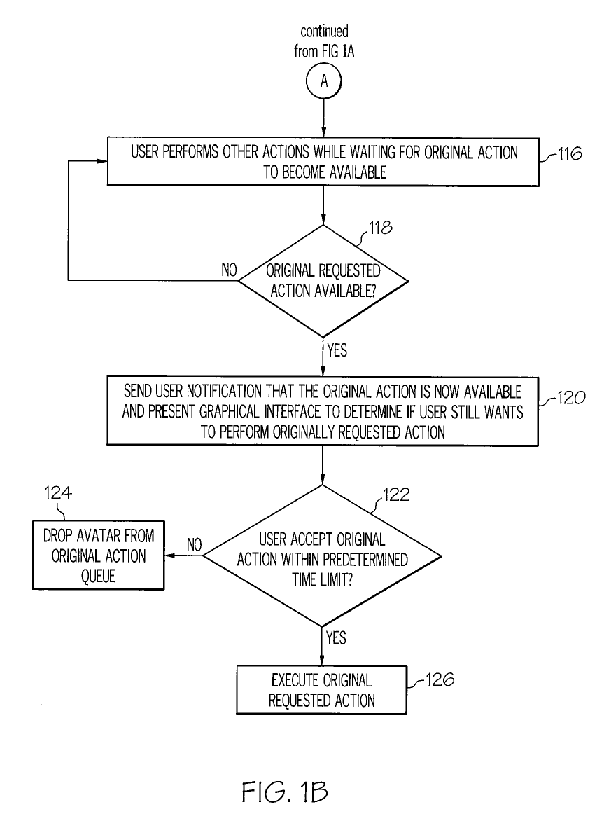

FIGS. 1A and 1B (collectively FIG. 1 ) are a flow chart of an example of a method for satisfying a request for an action in a virtual world in accordance with an embodiment of the present invention. In block 102, one or more predetermined GUIs may be presented to a user 101 for the user 101 to select an action for the avatar to perform. An action may include any action in a virtual world that an avatar may perform or which may be performed for an avatar. Examples of an action may include, but are not limited to, transporting the avatar to a specific location (e.g., taking a virtual trip or vacation), performing a service for the avatar (e.g. buying tickets for a concert, attending a concert, buying goods/services from a store, interacting with a concierge desk, interacting with a sales representative, and the like), etc. The GUI presented to the user 101 may be automatically displayed to the user 101 in response to the avatar triggering some stimulus in the virtual world, or the GUI may be displayed based on some input by the user 101, such as the user 101 pressing certain keys or clicking on an icon.

In block 104, once the GUI is presented to the user 101, the user 101 may then request the action or actions to be performed for the avatar. This may include entering information in the GUI. Alternatively, if no GUI has been presented, an action for the avatar may be requested solely in response to triggering some stimulus in the virtual world and thus a GUI would not be necessary. For example, if an avatar would like to request entry to the barber shop for a haircut, the avatar could open the door and enter the barber shop without a GUI being presented to ask the user if the user would like to request this service.

Regardless, once the request for an action is entered, the request may then be sent to a server or some other processing equipment. The server will process the request and determine whether or not the requested action is available, or whether the action is at full capacity, as shown in block 106. To do this, the server will locate the action that is requested and determine what the capacity of that action is. The capacity of the action may be set by a variable in computer software code associated with the requested action. The server will determine if the capacity is at its maximum threshold limit.

If a determination is made in block 106 that the requested action is available or that the capacity for the selected action is not at its maximum threshold limit, the method 100 may advance to block 108. In block 108, the requested action may be performed for the avatar. The capacity of the action may then be incremented accordingly.

Conversely, if a determination is made in block 106 that the capacity of the action is at its maximum threshold limit or for some other reason is unavailable, the method advances to block 110 and the user's request may be placed in a queue. When placed in the queue, the user's request is assigned a priority. Each user's request has a priority according to the order in which the request is received. Once the capacity of the requested action is first lower than the maximum threshold limit, the queue is processed to allow the avatar in the queue with the highest priority (i.e. the avatar who had the earliest request) access to the requested action.

In block 112 a notification may be generated to advise the user 101 that the requested action is not available and that the user's request has been placed in the queue. The notification may also advise the user 101 that she will not lose her place in the queue until further notice. The notification may further advise the user 101 that the user's avatar may perform other actions in the virtual world without losing the user's priority in the queue, so long as the user's original request remains in the queue. The notification may additionally present an option (e.g. depressing certain keys, clicking an icon, etc.) for the user 101 to remove the request from the queue at any time that the user 101 exercises such option. The notification may be presented visually or any other way, such as a synthesized voice or other type indication to alert and advise the user 101. The notification may also be presented to the user 101 immediately after the action is deemed to be unavailable for the avatar. Optionally, while the user's request remains in the queue, the notification may be displayed periodically or constantly to the user to remind the user 101 that her request is in the queue. For example, a small window, icon or the like may be presented in the corner of a computer screen, in a tool bar, banner, or elsewhere on the screen or display. Other information may be provided with the notification, such as the user's priority in the queue, an approximate time until the action may become available, other actions that are similar to the requested action or similar information related to the requested action.

The user 101 may also be notified as to what position or priority her request is in the queue, especially when an active avatar is removed from the requested action. This may be accomplished by presenting the user 101 a notification every time an active avatar stops performing or completes the requested action. Alternatively, the user 101 could be constantly updated as to what position or priority in the queue the user 101 has by displaying a priority notification constantly (or periodically) on the screen until the user 101 is removed from the queue.

In block 114, after the user's request is placed in the queue, the avatar is allowed to perform other operations in the virtual world while the user's request for the original action is still in the queue. This allows the avatar to continue exploring the virtual world while still waiting for the given request to be processed. This allows service providers, such as virtual stores, virtual consultants, virtual support, etc., to provide better service with minimal negative impact to the customers.

Thus, in block 116, the avatar may request and continue to perform other actions while the user's request for the original action is still pending. The present invention, however, is not limited to the avatar being placed in only one queue if multiple actions that the user requests are unavailable. Many times numerous actions that the user requests may also be unavailable and therefore, the user may be in multiple queues while still exploring the virtual world.

In block 118 a determination may be made if the originally requested action is available for the avatar. Continual checks may be performed to determine if the requested action's capacity is below the maximum threshold value or for some other reason the requested action have become available, such as a maintenance or repair issue has been resolved. If the originally requested action is still unavailable in decision block 116, then the method 100 may return to block 116. The method 100 may loop from block 116 to block 118 until the original requested action becomes available or the user 101 removes her request from the queue. The method 100 may advance to block 120 in response to the original requested action becoming available in block 118.

As illustrated in block 120, when the capacity drops below the maximum threshold limit for the requested action or the requested action otherwise becomes available, a spot may be saved or reserved for the requested action for the avatar in the queue that has the highest priority, as described above with reference to block 110. A notification that the requested action has become available may be sent to the user 101 of the avatar. Such notification may inform the user 101 that the originally requested action is now available for the avatar and that a spot is being held for the avatar for a predetermined time period (e.g. one minute, five minutes, etc.). The user 101 will then have the predetermined time period to accept the requested action.

In block 122, a determination may be made whether the user 101 has accepted the original action within the predetermined time limit or period. If the user 101 has not accepted the first or originally requested action within the predetermined time period, the method 100 may advance to block 124. In block 124, the user's avatar will be dropped from the queue for the originally requested action. The user's avatar may continue to perform the current action chosen by the user 101. Alternatively, the user 101 may not accept the originally requested action by either rejecting the offer to accept the requested action or by simply not responding within the predetermined time.

If the user accepts the originally requested action in block 122, the method 100 may advance to block 126. In block 126, the user 101 is dropped from the queue and the user's avatar is allowed to perform the requested action. Additionally, the user's avatar will stop performing any other actions in the virtual world chosen by the user while in the queue so that the avatar can perform the originally requested action. However, if the avatar is performing other actions while waiting for the requested action to become available, the user 101 may desire to continue the other actions before accepting the requested action. Thus, when the requested action becomes available and the avatar is performing other actions, a GUI may be presented to the user 101 for accepting the requested action that may include an option to delay acceptance of the requested action or commencement of the requested action until the user is finished performing the other actions or if a certain extended predetermined time period elapses. Accordingly, when the avatar is finished performing the other actions, the user may then reactivate the acceptance GUI and accept the originally requested action. That would then drop the request from the queue and then perform the originally requested action for the avatar. However, if the user does not finish the other actions within the extended predetermined time period, the user's original request may be dropped from the queue and the avatar would simply continue performing the other actions in the virtual world. Additionally, the GUI presented to the user 101 for accepting the originally requested action may also include an option for the user 101 to reset the user's request to a lower priority in the queue (or remove the user's request from the queue and then reinsert the user's request in the queue). When the user's request for the original action becomes allowable, the method 100 may return to block 122.

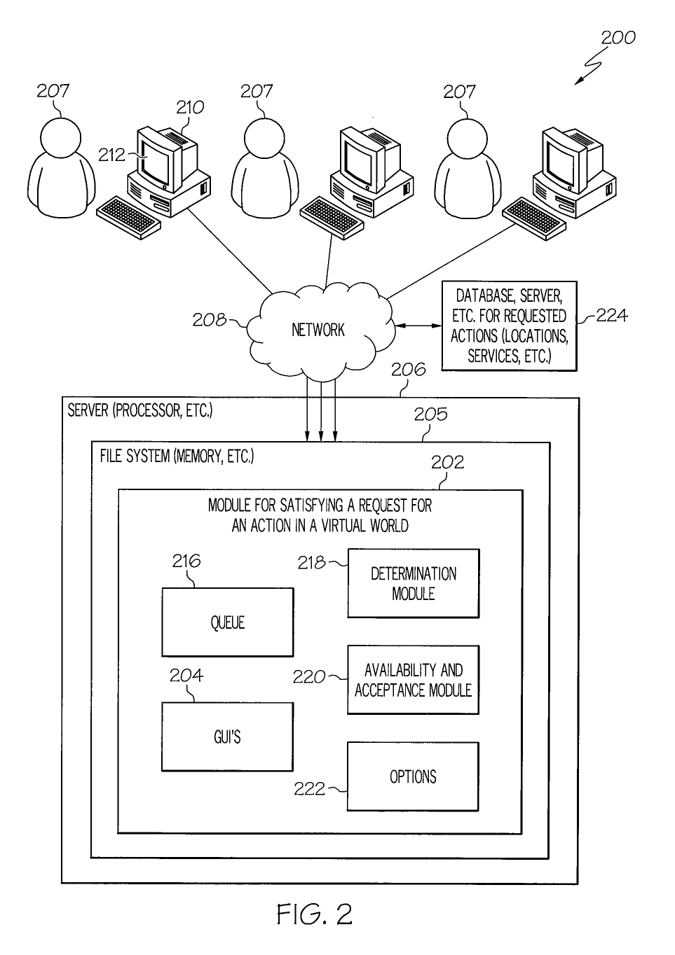

FIG. 2 is a block schematic diagram of an example of a system 200 for satisfying a request for an action in a virtual world in accordance with an embodiment of the present invention. The system 200 may include a module 202 for satisfying a request for an action in a virtual world (hereinafter “action request module 202”). The method 100 may be embodied in or performed by the action request module 202. The action request module 202 may present one or more predetermined graphical user interfaces 204 to permit satisfying of an action for virtual locations, goods or services in a virtual world or simulation and to permit a user to continue to request and perform other actions in the virtual world while still waiting for an originally requested action to become available similar to that described with respect to the method 100 in FIG. 1. The action request module 202 may be part of a virtual world simulation system or program, such as Second Life or similar virtual world system.

The action request module 202 may also be a self contained system with embedded logic, decision making, state based operations and other functions that may operate in conjunction with a virtual world simulation, such as Second Life. The self contained system may allow businesses, individuals, services, locations, and the like in the virtual world to interact with the avatar while the avatar is waiting for another action to become available.

The action request module 202 may be stored on a file system 205 or memory of a server 206 or other suitable data processing equipment. The action request module 202 may be accessed by a plurality of users 207, similar to user 101 in FIG. 1, or participants via a network 208 using an Internet browser on a personal computer 210 or by similar means. The network 208 may be the Internet, a private network or other network. The predetermined GUIs 204 that may be generated by the action request module 202 as described herein may be presented on a display 212 of the personal computer 210 to the user 207.

The action request module 202 may include a queue 216. The queue 216 is where the request for an action may be stored when a determination module 218 determines that a request for a particular action has exceeded capacity (maximum threshold limit) or is not available for some reason. Each request may be assigned a priority based on when the request was received and also each request is associated with the action requested. The earlier the request is received, the higher the priority that is assigned to the request. When a requested action has less than the maximum capacity and there are requests in the queue 216 for the action, the highest priority request for the action will be removed from the queue 216 and the avatar associated with that request will be given access to the action.

The action request module 202 may also include an availability and acceptance module 220. Portions of the method 100 in FIGS. 1A and 1B may be embodied in the availability and acceptance module 220. The availability and acceptance module 220 may present GUIs to the user to inform the user of the requested action's availability and whether or not the user would like to accept the requested action. Internet communications technologies or applications, such as Local Chat, Instant Messaging, e-mail, or similar communications means, may be used to permit informing the user of availability and acceptance or non-acceptance of the request by the user 207.

The action request module 202 may include an options feature 222. The options feature 222 may include any future enhancements, configurations, and extensions to the existing system or any additions relating to the action request module 202. As an example, a notification system could be added to the action request module 202 which could be configured as an option to email updates or provide notification by some other mechanism.

The system 200 may also include a database 224, server, or other mechanism to store actions and to present any requested actions in response to being requested by any of the users 207 for the user's avatar. As previously discussed, the actions may include, but are not necessarily limited to different locations that may be visited by avatars corresponding to the users 207 or participants, different services that may be provided to a user's avatar or other actions.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for satisfying a request for an action in a virtual world, comprising:
permitting a user to request a first action for the user's avatar in the virtual world;
receiving the request;
storing the request in a queue in response to the first action being unavailable to the user's avatar;
permitting the user's avatar to perform another action while the request for the first action is still in the queue;
determining if the first action becomes available for the user's avatar;
providing a graphical user interface to the user in response to the first action being determined to be available for the user's avatar;
allowing the user to accept the first action; and
allowing the user's avatar to perform the first action in response to the user accepting the first action.

2. The method of claim 1, further comprising allowing the user's avatar to continue to perform the other action in response to the user not accepting the first action when the first action becomes available.

3. The method of claim 1, further comprising:
allowing the user to reject the first action when the first action becomes available; and
dropping the user's request from the queue in response to the user rejecting the first action when the first action becomes available.

4. The method of claim 1, further comprising:
providing a predetermined time period for the user to accept the first action in response to the first action becoming available; and
dropping the user's request from the queue in response to the user not accepting the first action within the predetermined time period.

5. The method of claim 1, further comprising presenting a graphical user interface to the user to permit the user to request the first action.

6. The method of claim 1, wherein permitting the user to request the first action comprises permitting the user to request at least one of transporting the user's avatar to a selected location in the virtual world and the user's avatar receiving a chosen service.

7. The method of claim 1, further comprising providing the user with an option to select one of accepting the first action and delaying acceptance of the first action for a predetermined time period to finish the other action in response to the first action becoming available.

8. The method of claim 1, further comprising presenting a notification to the user of unavailability of the first action in response to the first action being unavailable when the user requests the first action.

9. The method of claim 1, further comprising presenting a notification to the user of availability of the first action in response to the first action becoming available while the user's request is in the queue.

10. A method for satisfying a request for an action in a virtual world, comprising:
permitting a user to request a first action for the user's avatar in the virtual world;
determining if the first action is unavailable for the user's avatar at the time of the request;
permitting a user's avatar to perform another action while the first action is unavailable for the user's avatar;
determining if the first action becomes available for the user's avatar;
notifying the user that the first action is available for the user's avatar in response to the first action being determined to be available;
allowing the user to accept the first action; and
allowing the user's avatar to perform the first action in response to the user accepting the first action.

11. The method of claim 10, further comprising allowing the user's avatar to continue the other action in response to the user not accepting the first action when the first action had been determined to be available to the user's avatar.

12. The method of claim 10, further comprising providing a predetermined time period for the user to accept the first action in response to the first action becoming available to allow the user's avatar to finish performing the other action after the first action becomes unavailable.

13. The method of claim 11, further comprising rescinding the request for the first action in response to the user not accepting the first action within the predetermined time period.

14. The method of claim 10, further comprising presenting a graphical user interface to the user anytime an input from the user is required.

15. The method of claim 10, further comprising placing the user request for the first action in a queue in response to the request for the first action being unavailable.

16. The method of claim 15, further comprising presenting a notification to the user that the first action is not available in response to the first action being unavailable and that the user's request will not lose its place in the queue for the first action in response to the request for the first action being unavailable and the user's avatar performing the other action.

17. The method of claim 10, further comprising presenting a notification to the user that the first action is now available in response to the first action being determined to be available.

18. The method of claim 15, further comprising allowing the user to select an option that will allow the user's request for the first action to stay in the queue in response to the first action becoming available and allowing the user's avatar to continue the other action.

19. The method of claim 10, wherein said first action is an action selected from one of transporting the user's avatar to a selected location in the virtual world and the user's avatar receiving a chosen service.

20. The method of claim 10, further comprising permitting the user to perform the other action while the request for the first action is still pending.

21. A method for satisfying a request for an action in a virtual world, comprising:
presenting a graphical user interface to permit a user to request a first action for an avatar in the virtual world, wherein the avatar corresponds to the user;
receiving a request for the first action;
performing the first action in response to the first action being available for the user's avatar;
providing a notification that the first action is unavailable in response to the first action being unavailable for the user's avatar at the time that the user requests the first action;
storing the request for the first action in a queue in response to the first action being unavailable for the user's avatar at the time that the user requests the first action;
permitting the user's avatar to perform another action while the request for the first action is still in the queue;
determining if the first action becomes available for the user's avatar;
sending a notification of availability of the first action in response to the first action being determined to be available for the user's avatar;
providing a graphical user interface to the user in response to the first action being determined to be available for the user's avatar;
providing a predetermined time period for allowing the user to accept the first action;
performing the first action in response to the user accepting the first action within the predetermined time;
allowing the user's avatar to continue to perform the other action in response to the user not accepting the first action within the predetermined time period; and
dropping the user's request for the first action from the queue in response to the user not accepting the first action within the predetermined time period.
